(19) United States
(12) Patent Application Publication
(10) Pub. No.: US 2024/0327747 A1
(43) Pub. Date: Oct. 3, 2024

(54) Composition and Method of Use of a Concentrated Asphaltene Polymer Residue from VTAE

(71) Applicant: Safety-Kleen Systems, Inc., Norwell, MA (US)

(72) Inventors: Abdel Mekhhal, Wilmington, DE (US); Joel W. Garrett, Wilmington, MA (US); Colin P. Colvin, McKinney, TX (US)

(73) Assignee: Safety-Kleen Systems, Inc., Norwell, MA (US)

(21) Appl. No.: 18/615,264

(22) Filed: Mar. 25, 2024

Related U.S. Application Data
(60) Provisional application No. 63/455,813, filed on Mar. 30, 2023.

(51) Int. Cl. C10M 175/00; C08L 95/00; C10G 7/06; C10G 21/00

(52) U.S. Cl. CPC C10M 175/0016; C08L 95/00; C10G 7/06; C10G 21/003; C08L 2555/34; C08L 2555/80; C10G 2300/1007; C10G 2300/206; C10G 2300/4081; C10G 2400/16

(57) ABSTRACT

Used lubricating oils are fed to a dehydration/fuel stripping unit to create de-watered/defueled feedstock which is fed to a Vacuum Distillation Column (VDC) to remove and send lighter fractions for processing into base oil. Vacuum Tower Asphalt Extender (VTAE) is collected from the Vacuum Distillation Bottom (VDB) of the VDC and fed to a Solvent Deasphalting unit (SDA) along with a hydrocarbon solvent, to create a Concentrated Asphaltene Polymer Residue (CAPR) containing concentrations of the depleted polymer additives and wear metals. In particular embodiments, the CAPR is used to create relatively high-grade asphalt binders suitable for paving applications.

### RELATED APPLICATION

This application claims the benefit of U.S. Provisional Patent Application Ser. No. 63/455,813, entitled COMPOSITION AND METHOD OF USE OF A CONCENTRATED ASPHALTENE POLYMER RESIDUE FROM VTAE, filed on Mar. 30, 2023, the contents of which are incorporated herein by reference in their entirety for all purposes.

### BACKGROUND

### Technical Field

The present invention relates to re-refining used lubricants or engine oil, and more particularly, to a process and product produced from further purification and refining of residual material collected in Vacuum Distillation Bottoms (VDBs) when re-refining used engine oil or other lubricants (lubricating oils).

### Background Information

Used engine oil, and other lubricants (lubricating oils), typically contain an array of impurities related to their exposures to certain conditions during their usage, including additives used to enhance lubrication oil performance. Conventional processes for purification and re-refining of recovered lubricating oils (such as used by Safety-Kleen Systems, Inc., of Norwell, MA) produce residual material collected in Vacuum Distillation Bottoms (VDBs), commonly referred to as Vacuum Tower Asphalt Extender (VTAE).

Conventional VTAE not only contains a substantial amount of high viscosity base oil but also contains significant amount of impurities, which tend to make the VTAE difficult to be fully integrated into asphalt binder for utilization in paving and other applications. Currently, commercial uses for VTAE tend to be limited to some roofing and particular low-grade asphalt paving applications.

A need exists for a process that addresses the foregoing drawbacks by refining VTAE more extensively to extract high viscosity base oil, and to facilitate the incorporation of the resulting concentrated residue into relatively high grade asphalt applications.

### SUMMARY

The appended claims may serve as a summary of the invention. The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a system incorporating an embodiment of the present invention;

FIG. 2 is a table of test results of material produced using embodiments of the present invention;

FIG. 3 is a table of test results of material produced using embodiments of the present invention;

FIG. 4 is a table of test results of material produced using embodiments of the present invention;

FIG. 5 is a table of test results of material produced using embodiments of the present invention;

FIG. 6 is a table of test results of material produced using embodiments of the present invention;

FIG. 7 is a table of test results of material produced using embodiments of the present invention;

FIG. 8 is a table of test results of material produced using embodiments of the present invention;

FIG. 9 is a table of test results of material produced using embodiments of the present invention;

FIG. 10A is table of test results of material produced using embodiments of the present invention;

FIG. 10B is a table of test results of material produced using embodiments of the present invention;

FIG. 11 is a table of test results of material produced using embodiments of the present invention

FIG. 12 is a table of test results of material produced using embodiments of the present invention;

FIG. 13 is a table of test results of material produced using embodiments of the present invention

FIG. 14 is a table of test results of material produced using embodiments of the present invention;

FIG. 15 is a table of test results of material produced using embodiments of the present invention;

FIG. 16 is a graph of test results of material produced using embodiments of the present invention;

FIG. 17 is a schematic view of an element of the embodiment of FIG. 1;

FIG. 18 is a graphical display of results generated using the element of FIG. 17; and

FIG. 19 is a table of metal content of materials produced using embodiments of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

As used in the specification and in the appended claims, the singular forms “a”, “an”, and “the” include plural referents unless the context clearly indicates otherwise. For example, reference to “an analyzer” includes a plurality of such analyzers. In another example, reference to “an analysis” includes a plurality of such analyses.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

### General Overview

The present invention relates to re-refining used lubricants or engine oil, and more particularly, to a process and product produced from further purification and refining of the residual material collected in the Vacuum Distillation Bottoms (VDBs) when re-refining used engine oil or other lubricants (lubricating oils). The VDBs are commonly referred to as Vacuum Tower Asphalt Extender (VTAE). The subject of this invention is the production of, and applications for, a material referred to herein as Concentrated Asphaltene Polymer Residual (CAPR) recovered from further processing and refining of the VTAE via solvent treatment such as provided by a Solvent De-Asphalting Unit (SDA).

An aspect of the present invention was the recognition by the instant inventor(s) that VTAE includes both oily components (e.g., mainly paraffinic materials), and semi-solid components in which impurities (e.g., metals, solid particles, products of oxidation, and depleted polymers and other additives used to enhance lubrication oil performance) are concentrated. They found that by carefully further refining the VTAE, the oily components may be removed to produce a heavy base oil useful in the production of lubrication oils. The remainder from this process is a semi-solid material (CAPR), in which the depleted polymers, additives, wear metals and the other impurities are concentrated.

Surprisingly, the inventors found that rather than merely being a waste product presenting a recycling/disposal challenge, the relatively highly concentrated depleted polymers in the CAPR have been shown to enhance the performance of asphalt binders into which the CAPR is blended. CAPR may thus be advantageously used in a number of applications including relatively high grade asphalt paving and roofing materials, as discussed in greater detail hereinbelow.

Moreover, although conventional wisdom holds that oxidation tends to adversely affect the properties of asphaltene materials, the inventors have found that the property enhancement provided by the polymers among the concentrated impurities, enable the CAPR to be oxidized without experiencing the expected level of adverse effects. Oxidation thus advantageously has been found to enhance the flowability of the CAPR, e.g., by forming a pelletized solid, to facilitate convenient transportation and further processing. The CAPR may also be blended with aromatic extract or other compatible renewable or bio-oil to create flowable CAPR in the form of a relatively low viscosity liquid for easy handling and transportation.

### Terminology

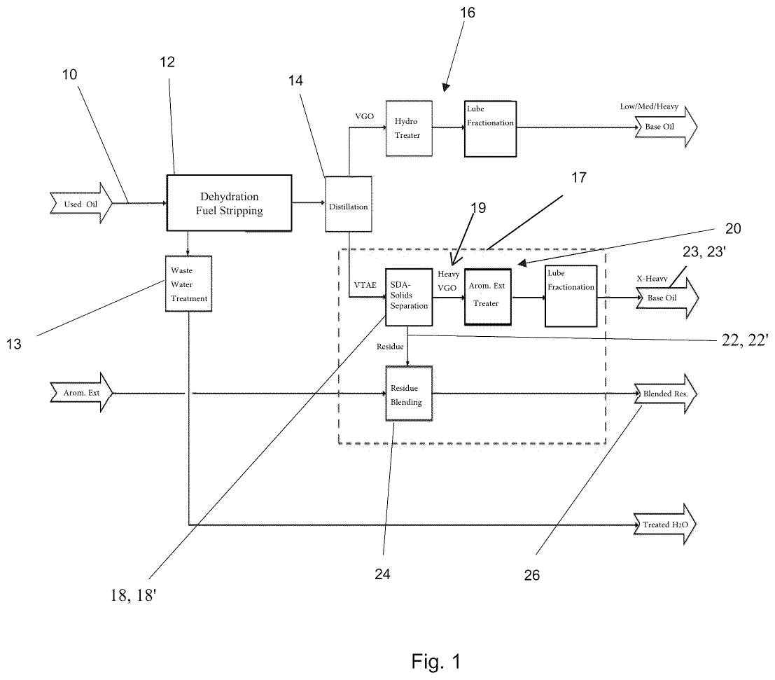

Referring now to the appended Figures, embodiments of the present invention will be more thoroughly described. Turning to FIG. 1, embodiments of the present invention include a modified version of a conventional process (such as that provided by Safety-Kleen) for purification and re-refining of used lubricating oils. As shown, this conventional process involves feeding used oil feedstock 10 to a dehydration and fuel stripping unit 12 that removes light fuel for sale or internal use and sends the recovered water to a wastewater treatment facility 13. The de-watered/de-fueled feedstock is sent to a vacuum distillation column 14 which removes lighter fractions and sends them to conventional facilities 16 (e.g., hydrotreating and lube fractionation systems) for processing into conventional base oil. The residue at the bottom of the column 14 is conventional VTAE.

The inventive process shown generally at 17 involves further processing the VTAE by combining it with a hydrocarbon solvent (not shown) at a Solvent De-Asphalting unit (SDA) 18, such as the ROSEs system commercially available from KBR, Inc. (Houston, TX), to effectively separate the concentrated solids/polymers/metals from the VTAE by solvent precipitation. The material 19 remaining after this solvent precipitation by SDA 18 includes oily components that are substantially solids free, which exhibit an overall reduced metals and impurities concentration, which are fed to facilities 20 (e.g., conventional hydrotreating and lube fractionation systems) for processing into a relatively heavy base oil 23. This heavy base oil may be used to produce various lubrication oils using conventional approaches. In particular embodiments, facilities 20 include a hydrotreater commercially available from Sequoia Global Inc. (Carson City, Nevada) with lube fractionation from Sulzer Management Ltd (Winterthur, Switzerland). Other hydrotreaters suitable for use in various applications are commercially available from Topsoe, Inc. (Houston, Texas), KBR, Inc. (Houston, Texas), Axens SA (Rucil Malmaison, France), and Sulzer. Other fractionation technology suitable for use in various applications is commercially available from Koch Glitsch, LP (Wichita, Kansas) and RVT Process Equipment, Inc. (Knoxville, Tennessee).

It should be recognized that facilities 20 may also separate and recover the hydrocarbon solvent that was used for the precipitation in SDA 18, for reuse in SDA 18. And, while propane is desirable in many embodiments, other hydrocarbon solvents usable by SDA 18 include one or more of pentane, hexane, n-pentane, n-heptane, and mixtures and combinations thereof. In particular embodiments, pentane and n-heptane are used alone and/or in combination with one another and/or with other solvents. In particular embodiments, SDA 18 is supplied with a solvent:VTAE ratio of 5-20 to 1, while in other embodiments, a solvent:VTAE ratio of 12 to 1 is used.

The material precipitated from the VTAE at SDA 18 is semi-solid Concentrated Asphaltene Polymer Residue (CAPR) 22, which has been found to contain the aforementioned wear metals and depleted polymer additives. CAPR 22 may be blended with other materials and/or oxidized at 24, to produce CAPR blends 26 that have been found to be useful in a variety of asphalt related applications, as discussed in greater detail hereinbelow.

In various examples, CAPR may be blended at 24 with base asphalt at ratios of: 0.5-100%; 0.5-30%; or in more particular examples, 5-30%, by weight. Percentages will depend on the particular base asphalt into which the CAPR is blended. In other examples, blending/oxidation 24 may include oxidizing and/or blending CAPR 22 with aromatic extract or other compatible renewable or bio-oil to produce a flowable/blended CAPR 26 in the form of a pelletized solid (via oxidation) or of a relatively low viscosity liquid (via aromatic extract or oil), for convenient transportation and further use in asphalt relation applications such as blending into paving and/or roofing materials.

To summarize, it should be noted that the industry has been struggling with what to do with VTAE left over from oil re-refining operations, because it is generally understood that that relatively high levels of oily fraction limit blending opportunities. It has also been understood that the various contaminants (metals, depleted polymers and other additives) found in used motor oil complicate recycling, while providing limited, if any, commercial or consumption benefits. The instant invention demonstrates, however, that the recovered residue has been found to have characteristics that are beneficial, and which surprisingly enhance, the properties of asphalt binder for a variety of asphalt related applications.

The inventors hereof discovered that rather than merely presenting a recycling/disposal challenge, the contaminants actually improved the physical properties of the resulting solid, making it a desirable additive for applications such as asphalt paving and asphalt roofing in which lower grade asphalts were essentially upgraded by blending with the CAPR While not wishing to be tied to any particular theory, it is suspected that removal of the oily fraction from the VTAE in the SDA enabled the metals and depleted polymers to coalesce with one another to form a relatively unified solid component that was then able to play a relatively large role in enhancing properties of the asphalt binder into which the CAPR was blended.

While SDA technology itself is not new, the inventors believe this is the first time SDA has been used to process VTAE as a feed as shown and described herein, to produce and recover significant volumes of heavy oil 23 that would otherwise end up sequestered in lower value applications. This use of SDA technology enables the production of heavy neutral Group II+ base oil, in a manner that is substantially infinitely recyclable.

It should also be recognized that alternative embodiments may use conventional Vacuum Distillation (e.g., Deep Vacuum or Short Path Distillation) 18′ instead of SDA 18. These alternative embodiments separate the oily and the solid fractions based on differences in their boiling temperatures. It is expected that the recovered residue (CAPR) 22′ and heavy base oil 23′ produced using these alternate embodiments may have slightly different properties than those produced using the SDA 18, e.g., due to differences in the relative percentages of the recovered oily and semi-solid residue fractions. In most applications, the SDA 18 produces a higher percentage of oily fraction, leaving CAPR 22 with a higher concentration of polymers than using Vacuum Distillation 18′.

The inventors believe this is the first time CAPR 22, 22′ produced from VTAE feed has been oxidized or blended with aromatic extract or compatible renewable or bio-oil at 24 to produce flowable CAPR 26 for easy handling and transportation in liquid or solid. As discussed hereinabove, conventional wisdom holds that while oxidation may be used to aid handling of asphalt material by pelletizing, doing so lowers the quality of the resulting material. However, the instant inventors have shown that the concentrated contaminants in the CAPR, including the polymers, provide the CAPR with improved properties that effectively offset the adverse effects of oxidation, etc.

It should also be noted that CAPR 22, 22′ is distinct from VTAE, because VTAE retains the molecular structure indigenous to crude oil refining. CAPR, on the other hand, includes recovered wear metals and depleted polymer additives that had previously been added to enhance the finished lubricant performance and later recovered with the used oil feedstock. The inventive process for producing CAPR from VTAE should thus be viewed as promoting sustainability, recycling and carbon footprint reduction. Both the recovered oil fraction resulting in heavy base oil 23, 23′ and the CAPR 22, 22′ may be considered recycled material.

Moreover, it should be recognized that typical asphalt used for roofing applications costs more from refineries than does paving grade asphalt. By effectively upgrading it, the inventive approach permits lower value paving grade asphalt to be used in higher value roofing applications. In many applications, the products in which CAPR 22, 22′ has been incorporated exhibit enhanced performance properties, e.g., longer useful life than conventional materials.

### Example Applications

Representative applications for CAPR as shown and described herein include the following:
Paving—Asphalt binder: CAPR may be combined with paving grade asphalt to improve its resistance to aging.
a CAPR may be used to improve the performance of asphalt mixtures containing Reclaimed Asphalt Pavement (RAP) and or Reclaimed Asphalt Shingles (RAS).
Soft asphalt—CAPR may be used to harden soft asphalt to meet a specified grade.
Purify neat (liquid phase) asphalt—If an asphalt does not meet certain specified criteria, blending with CAPR may help meet properties by dilution, etc.
Short and long-term aging—CAPR may enhance the aging characteristics of paving and industrial asphalt materials.

Laboratory experiments have shown that blending the CAPR 22, 22′ with paving-grade asphalt binders produced a superior flux grade of petroleum asphalt useful in the asphalt paving industry. As demonstrated by the test results described hereinbelow, the produced engineered binder exhibited significant beneficial properties concurrently improving both high and low temperature PG (performance grading) properties. The high temperature compliance (HTC) of the asphalt binder was increased by one grade and maintained the low temperature compliance (LTC) at typical dosage. In addition, the produced binder exhibited improved A Tc (an asphalt binder performance parameter for evaluating age related cracking potential) at both 20 and 40 hours of PAV aging (Pressure Aging Vessel procedure in AASHTO M320). Also, the asphalt binder containing CAPR revealed no adverse effect on flash, solubility, or tack properties.

The attained benefits in the asphalt binder from adding the CAPR were supported and confirmed in asphalt pavement performance testing. Pavement performance properties from a balanced mixture design approach showed improvement in moisture susceptibility. Wet and dry tensile strength results were improved in comparison to neat asphalt binder without CAPR. CAPR may be used as an anti-stripping agent for asphalt pavement.

Adding CAPR to paving grade asphalts stiffens the asphalt replacing air blowing technology which would result in reduction in air pollution and carbon footprint. Also, blending CAPR with paving grade asphalts may fully or partially replace more expensive polymers used to increase paving grade asphalt. CAPR offers a better alternative to using poly phosphoric acid (PPA) currently used to stiffen paving grade asphalt. Modifying paving grade asphalt binders with CAPR stiffens the asphalts (increases complex modulus), permitting use in asphalt pavements and related products such as crack and joint sealants.

CAPR may also be used in paving to produce a stiffer higher modulus binder for use in base courses designed to withstand higher stresses from heavy vehicular traffic such as heavy commercial trucks, planes, and trains. CAPR may also provide pavements with improved resistance to thermal and fatigue cracking. Improvements were noted in CAPR-infused pavements that were aged by accelerated means.

Also, lab worked showed benefits in asphalt roofing applications when CAPR was used. For instance, by combining the CAPR with asphalt or bitumen binder, and processing this combined material using typical conditions of asphalt oxidation (e.g., heating the combined material at 400° F.+ and applying a controlled flow of air through the material), it was discovened that the processing time required to achieve desirable material properties was reduced significantly. The resulting oxidized product exhibited improved performance characteristics offering better durability after aging.

It was discovered that CAPR blended with relatively low quality paving-grade asphalts produced a superior flux grade of petroleum asphalt capable of being used in the asphalt roofing industry where higher quality materials are required. When the engineered flux was air blown, a process in which air is bubbled through asphalt at elevated temperatures (400° F.+), the result is asphalt with improved thermal stability. The resultant material is less susceptible to flow or deformation at the typical elevated temperatures incurred during use. It is understood that the air blowing process is controllable by altering the temperatures, air rates, air dispersion within the asphalt and diffusion of air through the volume of asphalt (contact time). Typically, the degree of air blowing is measured by increases in the asphalt's complex modulus measured by Softening Point. The asphalt flux is air blown to meet the requirement of the product use. It is also important to retain the air blown product's low temperature properties, flexibility, to provide utility and usability of the product at cold temperatures.

It was discovered that blends of CAPR with paving grade asphalts (engineered flux) resulted in air blown products, coatings, which met and/or surpassed the requirements established by the asphalt roofing industry. Improvements identified were reduced air blowing times, improved Softening Point/Penetration at 25° C. relationship, improved (increased) flash point, improved cold temperature mandrel bend test temperatures (CTMB), improved accelerated weathering, reduced stain index, improved cold temperature flexibility, while retaining process viscosities like standard, non-engineered fluxes.

In the roofing industry, these improvements exhibit efficacy in both the steep and low slope roofing sectors, typical product types are built-up roofing mopping asphalt, ply and cap sheets, shingles, rolled roofing products, and components of shingles such as tab sealants and laminating adhesives.

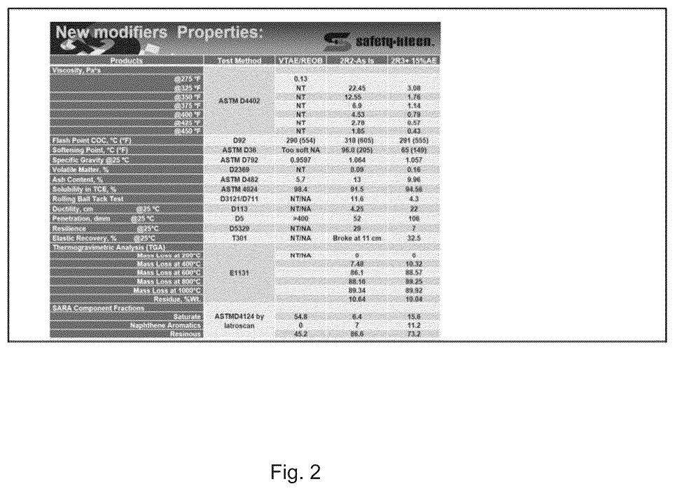

Test results for the inventive CAPR 22 and CAPR blend 26 are shown and described hereinbelow with reference to the accompanying figures. In these test reports, CAPR 22 is variously referred to as Asphalt Modifier(s) (‘Modifier’) R1, 2R2 and/or 2R3. The R1 was produced in the first pilot run and it is the same as 2R2 which was produced in the 2nd pilot run. Neither R1 nor 2R2 were combined with any Aromatic Extract (AE). 2R3 is the same material as 2R2 but contains aromatic extract AE at 15% (weight percent). Test results are included for R1 alone, 2R2 in a CAPR blend 26 without AE, and 2R3 in a CAPR blend 26 with AE. All percentages shown and described with reference to FIGS. 2-17 are weight percentages.

Turning to FIG. 2, Modifier 2R2, Modifier 2R3, and a conventional VTAE control, were subjected to a series of tests for parameters including Flash Point, Softening Point, Specific Gravity, Volatile Matter, Ash Content, Solubility in TCE, Rolling Ball Tack, Ductility, Penetration, Resilience, Elastic Recovery, Thermogravimetric Analysis (TGA), and SARA Component Fractions. Results of this testing are shown in FIG. 2, and demonstrate significant differences/improvements relative to the VTAE control.

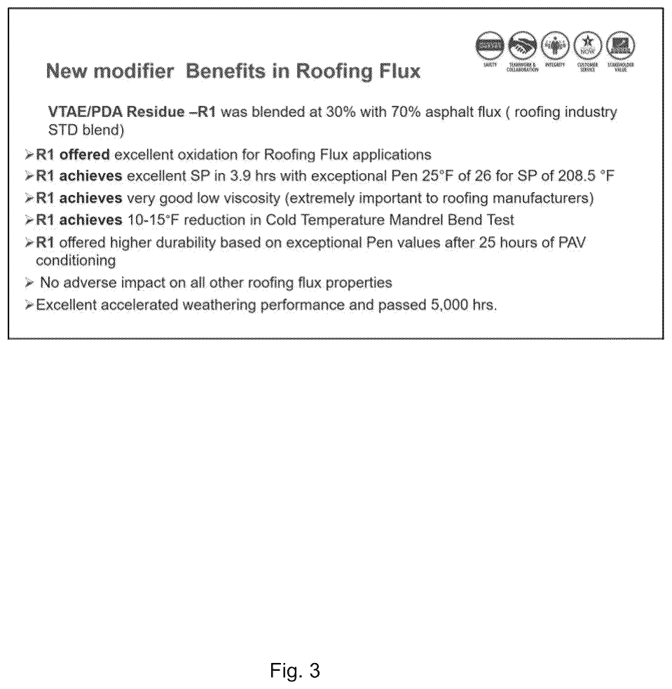

Referring to FIGS. 3-17, these Modifiers were tested in various applications and blends. Unless otherwise specified, the Modifiers were mixed/blended in a manner commonly used with conventional PMA liquid asphalts. The Modifiers were heated at 250° F. or above and then added to heated liquid asphalt binders at temperatures above 250° F., and blended with the host asphalt by means of paddle agitation and/or circulation until homogeneity was achieved.

Turning to FIG. 3, Modifier R1 was mixed with conventional asphalt flux for roofing applications (roofing industry standard blend) at a ratio of 30% to 70% by weight. No other catalysts or additives were added). This blend was mixed at 325° F. for 30 minutes (at which time the mixture was determined to be visually homogenous).

A 2000 g sample of the mixture was added to a conventional oxidation still, and then heated to a target temperature of 515° F. Air was blown through the sample at a rate of 2 liters per minute while mixing and maintaining the target temperature. The sample was then oxidized to a target softening point of 210° F., taking 3.9 hours. Test results for the mixture are summarized in FIG. 3, demonstrating favorable results in roofing applications.

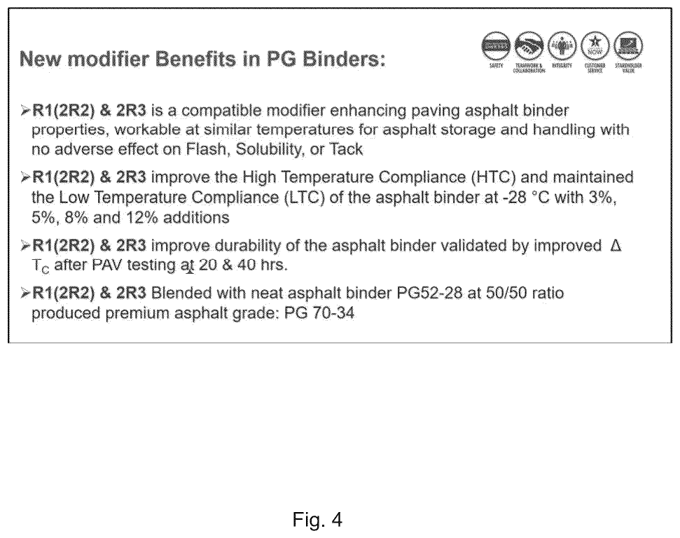

Referring now to FIG. 4, Modifiers R1 and 2R3 were blended with conventional PG (performance-graded) binders used in paving applications. In the PG binder system, engineering properties related to performance are measured at temperatures corresponding to the climatic and traffic conditions of an expected pavement location. For example, a binder of PG 64-22 corresponds to a binder rated for an average 7-day maximum pavement temperature of 60 degrees C., and minimum pavement temperature of 21 degrees C. The PG binder system thus allows selection of a binder grade that is specifically suited to a particular paving application. As shown, the Modifiers R1 and 2R3 improved many properties of the binders, and when blended with neat asphalt binder PG 52-28 at a 50/50 weight % ratio, produced a premium asphalt grade of PG 70-34.

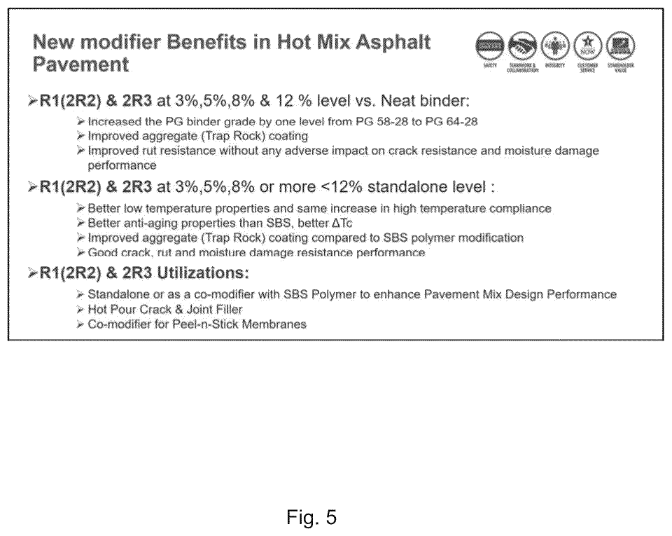

Turning now to FIG. 5, Modifiers R1 and 2R3 were blended at 3%, 5%, 8% and up to 12%, with neat PG 58-28 binder. This blending improved many properties of the binder, raising the PG binder grade one level to PG 64-28.

Moreover, initial testing of Modifiers R1, 2R2 and 2R3 related to “tack” and durability suggests significant improvement of desired properties in peel-and-stick roofing products. Initial testing related to “tack” and low temperature performance suggests significant improvement of desired properties in hot-applied crack sealant products, which typically include a polymer content of over 15%.

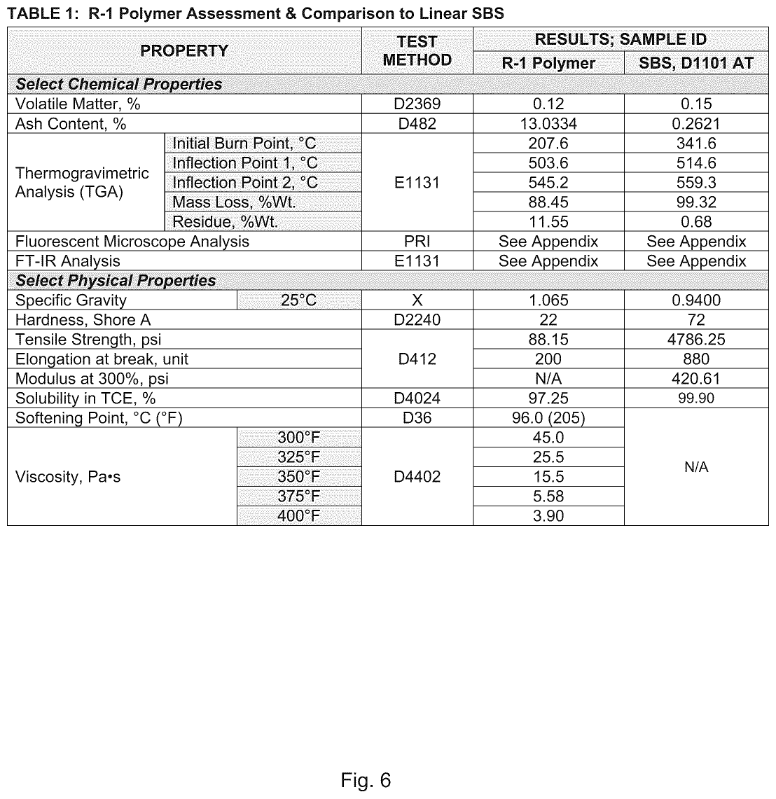

Referring now to FIG. 6, Modifier R1 was compared to a conventional industry standard polymer elastomer SBS (styrene-butadiene-styrene) bituminous modifier, and to PG 52-28 asphalt binder. Test results showed that R1 is compatible for use with paving asphalt binder, and should also show efficacy in both Paving and Roofing applications. R1 exhibited significant improvement in both high and low temperature PG properties, in viscosity, and in durability, relative to SBS. In particular, the viscosity profile determined R-1 is workable at 300-400° F., which are temperatures common to asphalt storage and handling. R1 also exhibited a Solubility TCE of 974%, suggesting solubility in asphalt.

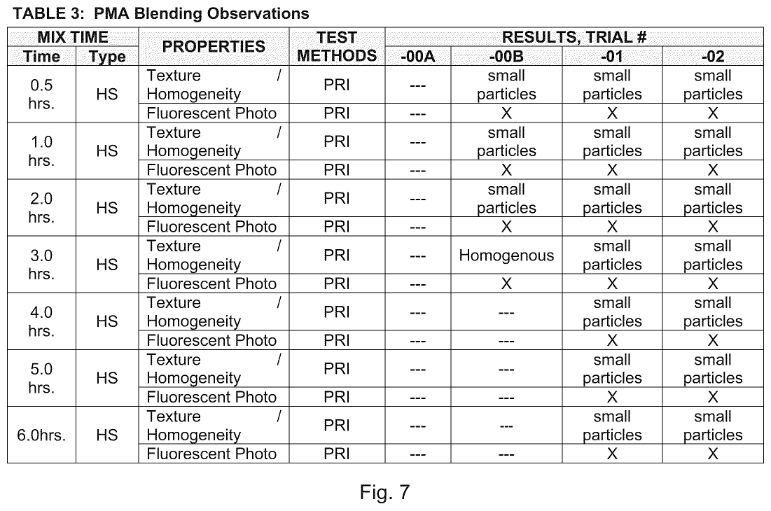

Turning now to FIG. 7, R1 was evaluated by blending in different concentrations with PG 58-28 base asphalt. As shown in Table 2, four initial samples were made: −00A (Neat PG 58-28 Base without modification); −00B (PG 58-28+3% Common SBS); −01 (PG 58-28+3% R1); and −02 (Pg 58-28+8% R1). The base asphalt was heated to 385° F. and SBS/R1 polymers were added after reaching stable temperature. Conventional High-Shear mixing was used until the samples had achieved microscopic fluorescence. It is noted that R-1 alone did not exhibit fluorescence.

As shown, after only limited blending time (0.5 hrs.) the R1 blends appeared visually homogenous. Small particles appear on the fluorescent microscope slides, as with the control, and did not dissipate over time during further blending.

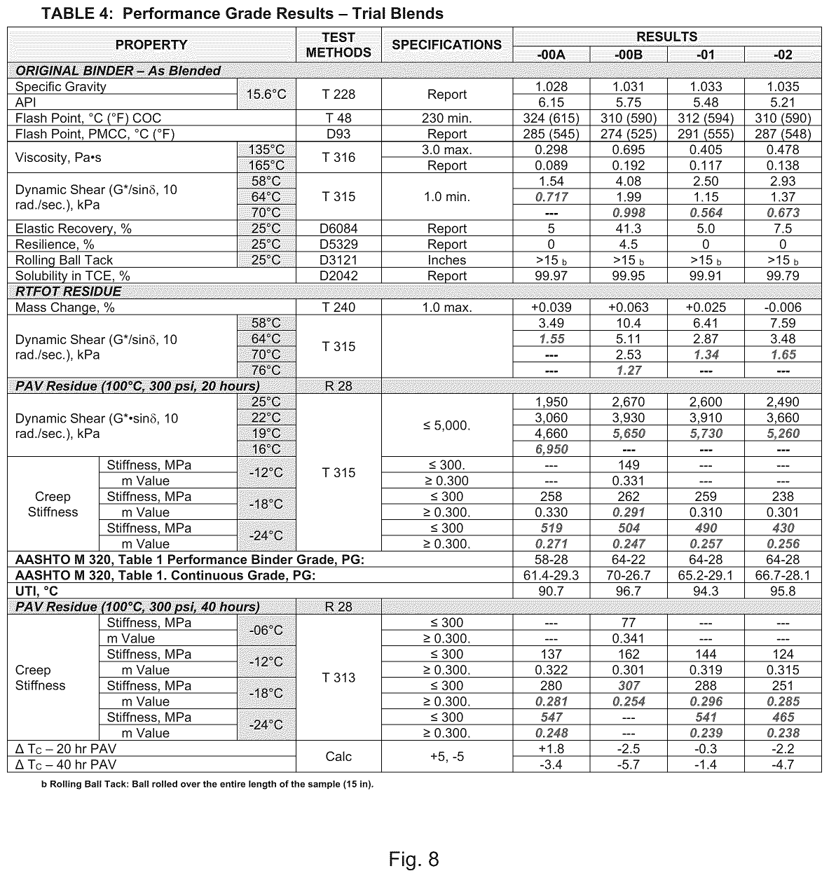

Turning to FIG. 8, samples shown and described with respect to FIG. 7 were tested for various parameters indicative of suitability of R1 for use as a paving grade asphalt modifier. This testing indicated that R1 increased the high-end grade of the asphalt binder at typical dosages. R1 maintained the low temperature PG, −28° C. at both 3% and 8%, which is a significant finding, since the conventional SBS exhibited a loss of low temperature grade, from −28 to −22° C. The 01 sample with 3% R1 exhibited an approximate 40% improvement in viscosity relative to the SBS control. Results showed improved A Tc at both 20 and 40 hours of PAV aging. The ΔTc of the R1 at PAV 40 hrs. were significantly better than the SBS values. Based on ΔTc. R1 exhibited improved durability. The use of R1 had no significant adverse effect on Flash, Solubility, or Tack. Overall, the data suggests that higher percentages of R1 would be feasible and expected to yield further performance improvements.

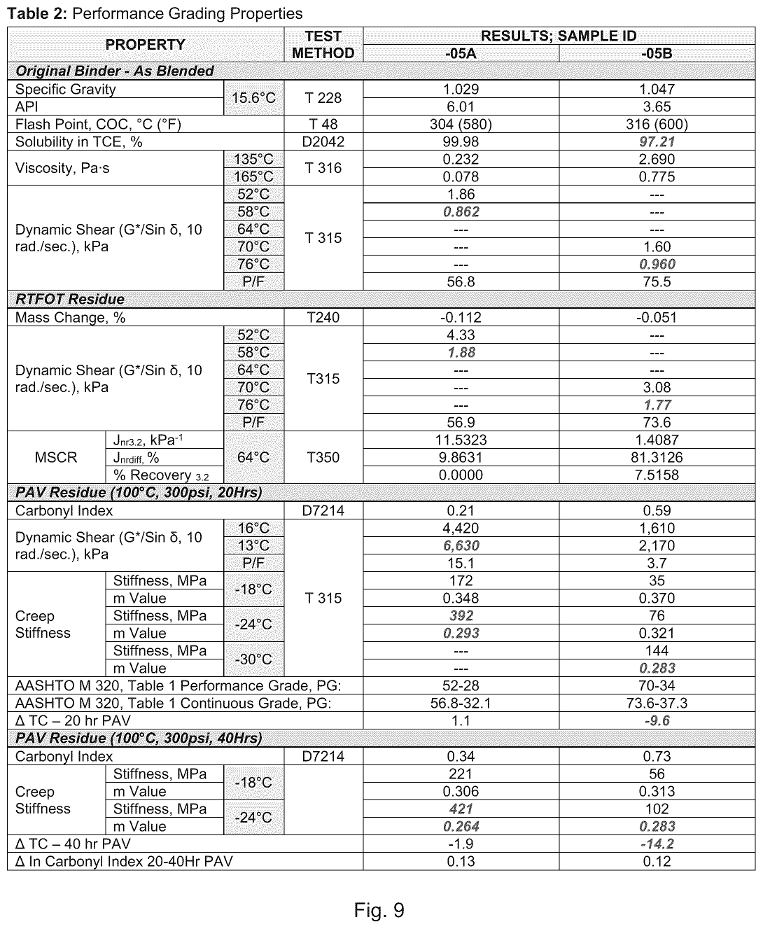

Referring now to FIG. 9, sample −05B of 2R2 blended with PG 52-28 base asphalt at a ratio of 50% by weight was compared to sample −05A of 100% PG 52-28. Objectives were to evaluate the effects of 2R2 on the asphalt binder grade when added at a relatively high concentration, while also determining the effectiveness of the use of asphalt binder as an additive to aid in the storage, shipping and transport of 2R2.

Results indicated that viscosity and stiffness were in a range that would not require abnormal temperatures or handling protocols in a facility accustomed to handling asphalt. There was no indication that any adverse effects would arise if asphalt were used in place of aromatic oil to aid in sample storage, transport and delivery.

In preparation for testing, the samples were blended at 350° F. for 30 minutes using low shear paddle mixing. The 2R2 easily and quickly mixed into the asphalt binder to make a homogenous sample. The results showed that the 2R2 of sample 05B effectively improved both high temperature and low temperature properties relative to 05A.

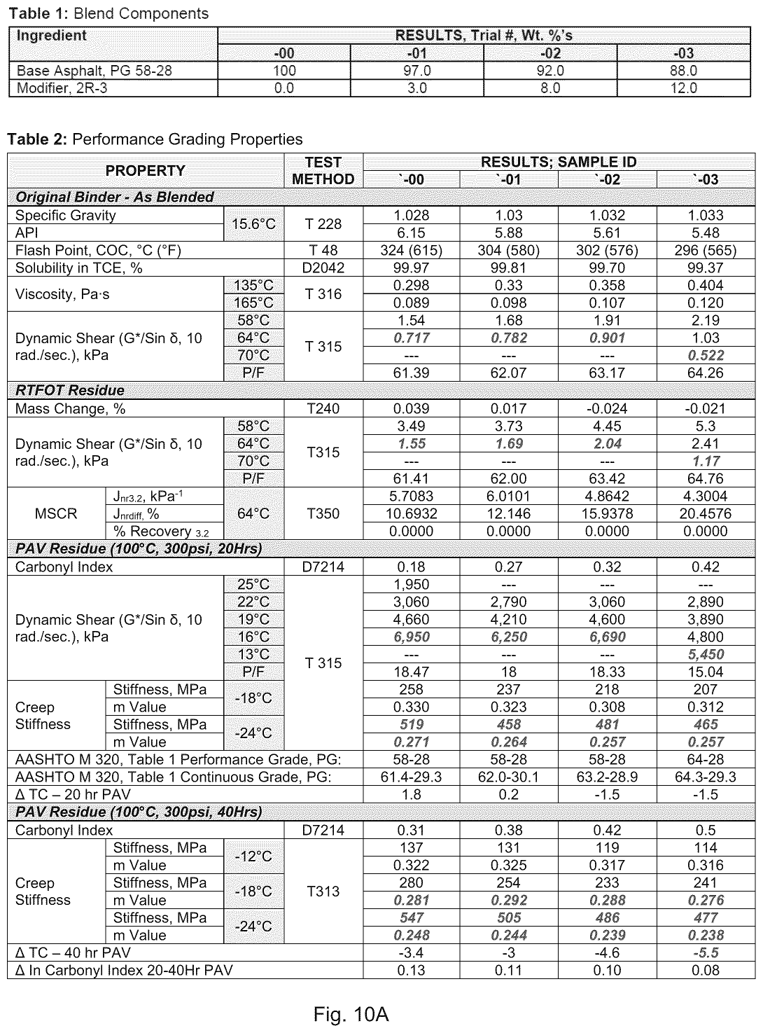

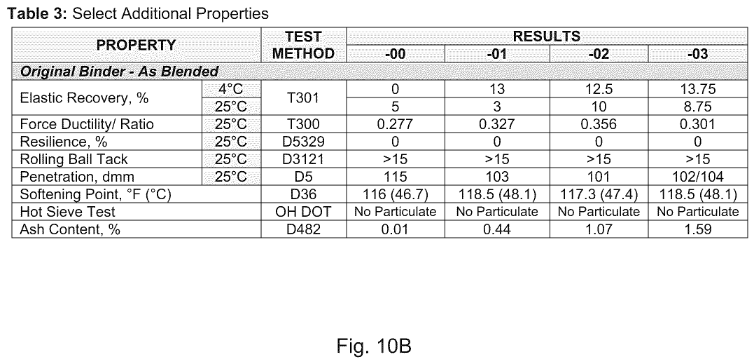

Turning to FIGS. 10A and 10B, Modifier 2R-3 was blended with PG 52-28 at 3, 8, 12 weight %, in samples 01, 02, and 03, respectively. Objectives were to evaluate the efficacy of 2R3 as an additive for paving grade asphalt binders by determining the effects of 2R3 on high and low temperature properties of AASHTO Performance grading, and to evaluate effects of 2R3 on additional select properties related to paving, roofing, and pavement preservation products.

The test results indicated that 2R3 increases the high temperature PG properties while having a negligible effect on most low temperature properties. 2R3 increases low temperature elasticity. 2R3 also increases the amount of ash and non-soluble material in the asphalt blends, which may need to be addressed in some applications.

In preparation for testing, the samples were blended at 350° F. for 30 minutes using low shear paddle mixing. The 2R3 easily and quickly mixed into the asphalt binder to make a homogenous sample. The results indicated that the high temperature grade increases with the addition of higher levels of 2R3, without significantly affecting the low temperature performance grade. Solubility data suggests that a maximum amount of 2R3 is likely near 15% before the resulting blend will not meet the minimum solubility requirement.

In addition, 2R3 increases the elasticity of the asphalt blends, particularly at relatively cold temperatures. This may be a significant benefit in some applications, to counter the general tendency of elasticity to decrease in colder temperatures. The addition of 2R3 also slightly hardens the asphalt, lowering the penetration, and increasing the softening point.

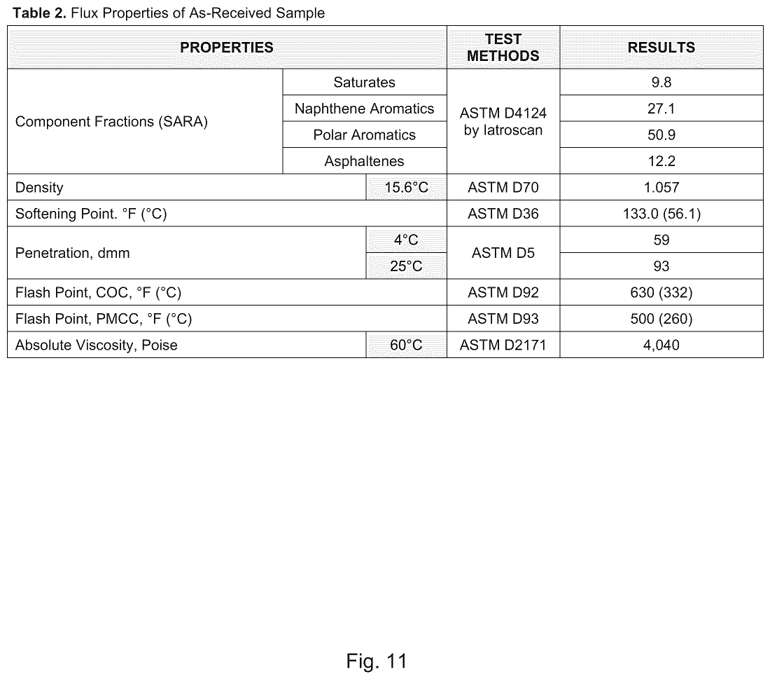

Referring to FIGS. 11-14, Modifier R1 was blended with conventional roofing flux and tested to assess applicability of R1 to roofing applications. Properties tested included Flux, Oxidation, Coating, and PAV Aged Coating.

Conventional asphalt flux was mixed with R1 at a ratio of 70 to 30 weight percent. (No other catalyst or additives were added). The blend was mixed at 325° F. for 30 minutes, at which time the blend was visually homogenous.

A 2000 g sample of the blend above was added to a conventional oxidation still, then heated to a target temperature of 515° F. Air was blown through the sample at a rate of 2 liters per minute while mixing and maintaining the target temperature. The sample was oxidized to a target softening point of 210° F., taking 3.9 hours.

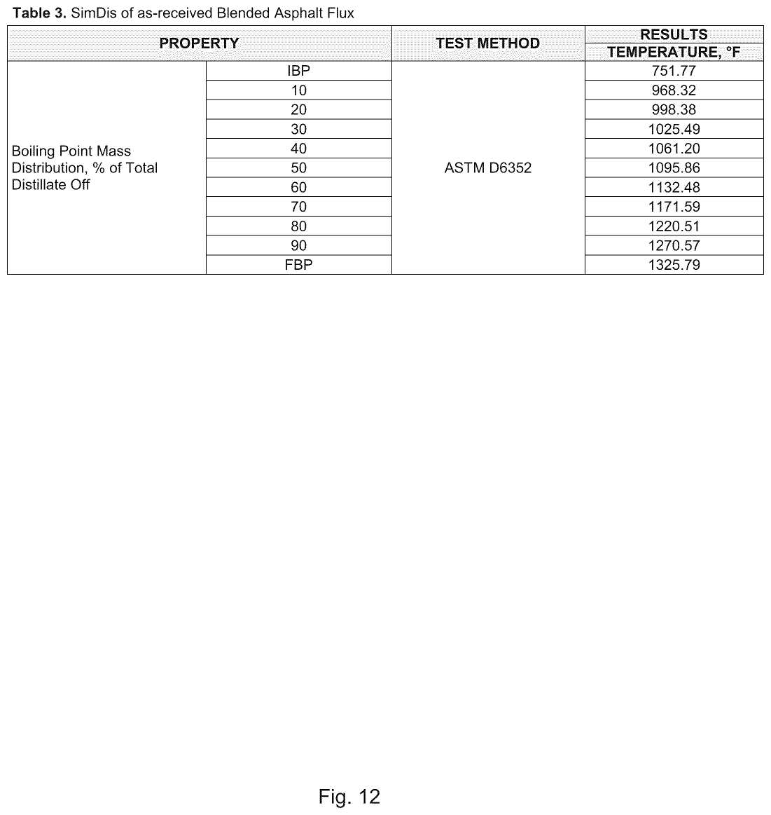

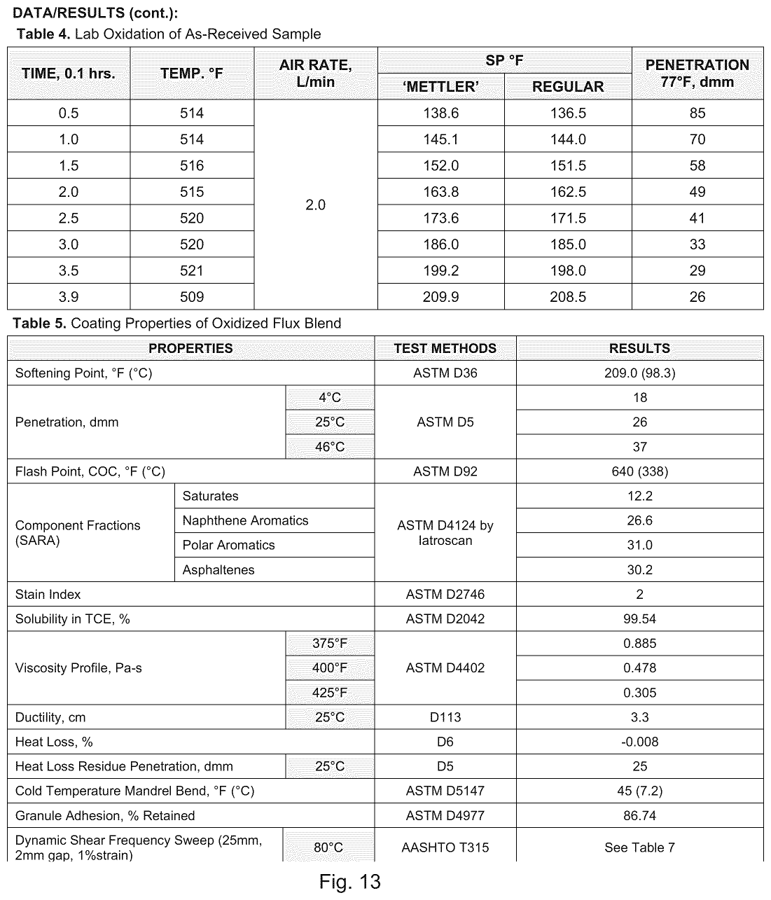

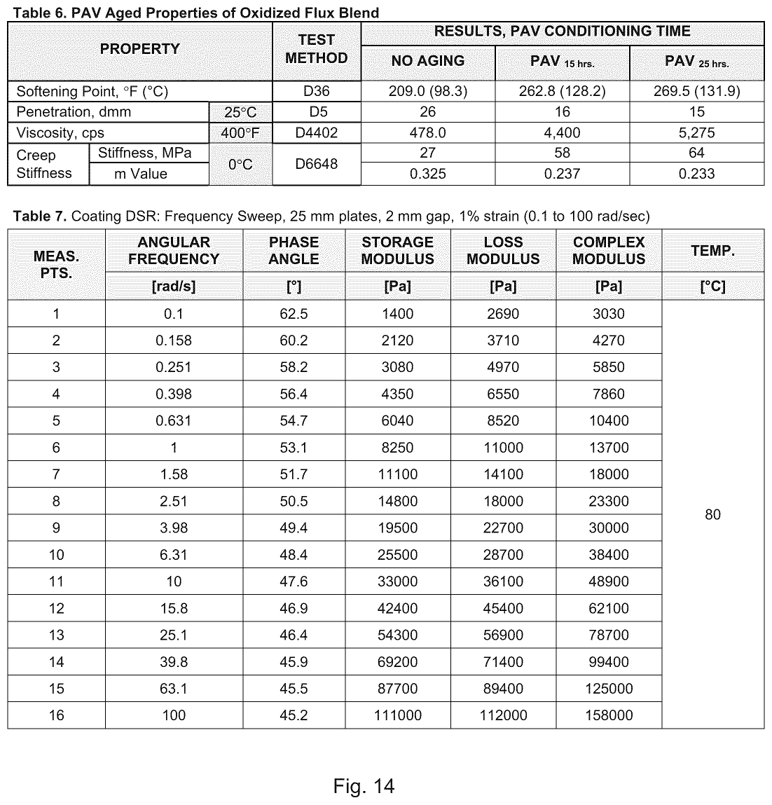

Flux properties of the sample are shown in FIG. 11, simulated distillation properties are shown in FIG. 12, oxidation properties are shown in FIG. 13. PAV Aged Coating, and Coating, results are shown in FIG. 14.

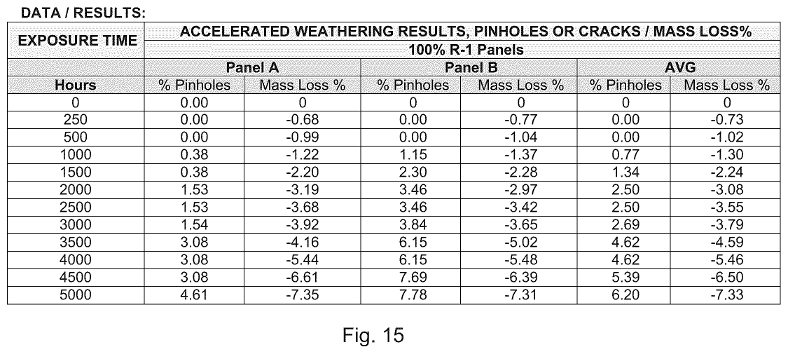

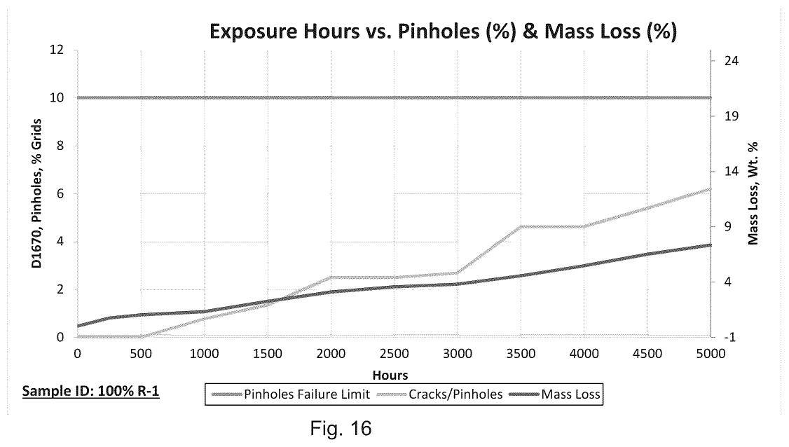

Referring to FIGS. 15-16, Modifier R1 was tested for Accelerated Weathering Protocol Requirements, for use as a shingle coating. A sample panel was (1) prepared in accordance with ASTM D1669, (2) inspected at pre-selected intervals in accordance with ASTM D1670, and (3) subjected to accelerated weathering exposure in accordance with ASTM D4798.

Test results indicated that the R-1 sample did not fail after 5000 hours of accelerated weathering. The sample exhibited less mass loss than conventional roofing asphalts. Pinholes and cracks formed on the sample surfaces were less than average, and formed at a slower, more linear rate than a conventional roofing asphalt. The R1 sample also exhibited less visual fade than conventional roofing asphalt samples, remaining darker in color, while most conventional binders fade when weathered.

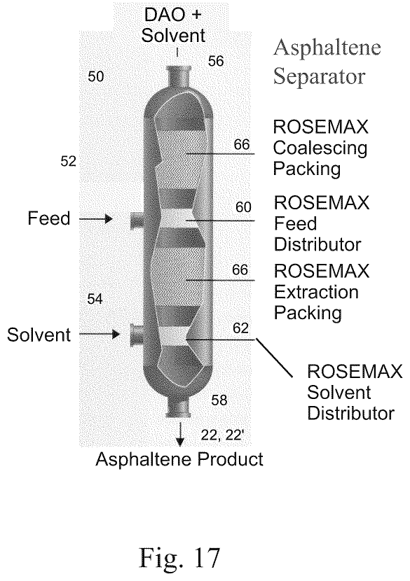

Referring now to FIG. 17, a ROSE® Solvent De-Asphalting unit (SDA) 18 was used to separate the concentrated solids/polymer/metals from the VTAE by solvent precipitation. As shown, SDA 18 includes a vertically oriented tower 50 including a feed inlet 52 disposed above a solvent inlet 54. Light and heavy product outlets 56 and 58 are respectively disposed at upper and lower ends of tower 50. Within tower 50, a feed distributor 60 is disposed in fluid communication with feed inlet 52, a solvent distributor 62 is disposed in fluid communication with solvent inlet 54, and packing 66 is disposed between and above distributors 60, 62.

As testing was initiated, SDA 18 was operated in counter-current mode at a volumetric solvent-to-oil ratio of 8:1. The observed yield of oil from light product outlet 56 at this condition was approximately 66 wt % and was visually indicative of good quality. However, operators observed that the asphaltene was not flowing at the expected rates from heavy product outlet 58, indicating that material was accumulating in the SDA 18.

Operation in counter-current mode was then stopped and SDA 18 was then operated in Mixer-Settler mode. In this configuration the solvent was mixed with the feed before being introduced at inlet 52, and the volumetric solvent-to-oil ratio was increased from 8:1 to 12:1 at a temperature of 85° C.

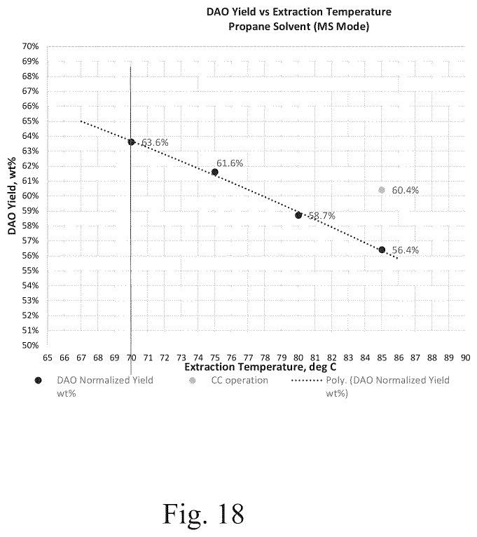

Turning to FIG. 18, an initial production run was completed with an oil yield of 56.4 wt/o, and was visually indicative of good quality. The asphaltene produced was sticky but hard Enough to hold as a solid chunk. A second production run was completed with an oil yield of 63.6 wt %. Visual observation showed a darker but acceptable color and the asphaltene material had a stringy consistency.

After the conclusion of the Mixer-Settler runs, the SDA 18 was again put into counter-current mode, at a reduced flow rate. The counter-current operation achieved an oil yield of 60.4 wt % at a temperature of 85° C. compared to an oil yield of 56.4 wt % in Mixer-Settler mode at the same temperature. The color was indicative of acceptable oil quality and the asphaltene had a stringy consistency.

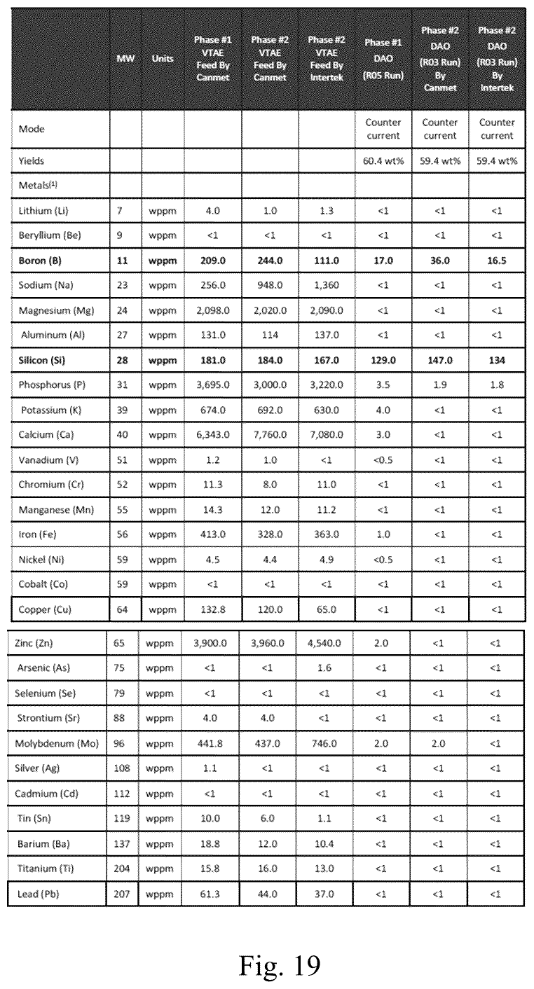

Referring now to FIG. 19, the table presents VTAE feed from Phase #1 and Phase #2 feedstocks. Countercurrent DAO (material 19) from Phase #1 run R05 at 60.4 wt % yield was presented as benchmark Phase #1 results. Phase #2 run R03 at 59.4 wt % DAO (material 19) yield metal product analysis results were analysed at Canmet by a 3rd party lab and additionally at Intertek laboratories. The metals are listed in their respective molecular weight order.

The table of FIG. 19 includes metals that were detected in the VTAE fed to SDA 18 and in material 19 (DAO) emerging from SDA 18 (FIG. 1). Some metals species fall below <1 wppm analytical detection level. Both Canmet and Intertek labs used ASTM D5185, ASTM D8110 and ASTM D5708 methods for producing the results, with different dilution levels and various diluents (organic and non-organic) as appropriate. The table presents metals in the VTAE to compare with analysed material 19 (DAO) metals contents from both Phase #1 and Phase #2 tests. The metals are arranged in ascending MW (rounded) order. Results of material 19 (DAO) measurements show a high level of rejection from VTAE feedstock by solvent extraction in both Phase #1 and Phase #2, as can be seen by analytical results that are reported as <1 wppm (i.e., at or below minimum detection levels). This high level of rejection of contaminants to the CAPR 22 demonstrates the benefit of utilizing SDA 18 for concentrating the contaminants within the CAPR 22 and producing clean, high quality material 19 for use in base oil 23.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. It should be further understood that any of the features described with respect to one of the embodiments described herein may be similarly applied to any of the other embodiments described herein without departing from the scope of the present invention. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims. It should be further understood that any of the features described with respect to one of the embodiments described herein may be similarly applied to any of the other embodiments described herein without departing from the scope of the present invention.

Having thus described the invention, what is claimed is:

1. A method for refining residual Vacuum Tower Asphalt Extender (VTAE) collected in a Vacuum Distillation Bottom (VDB) of a Vacuum Distillation Column (VDC) when re-refining used lubricating oils containing depleted polymer additives and wear metals, the method comprising:
(a) feeding used lubricating oils as a feedstock to a dehydration/fuel stripping unit to create de-watered/defueled feedstock;
(b) feeding the de-watered/defueled feedstock to a VDC to remove and send lighter fractions for processing into base oil; and
(c) collecting VTAE from the VDB of the VDC and feeding the VTAE to a Solvent Deasphalting unit (SDA) along with a hydrocarbon solvent, to create a Concentrated Asphaltene Polymer Residue (CAPR) containing concentrations of the depleted polymer additives and wear metals.

2. The method of claim 1, comprising:
(d) further processing the CAPR to facilitate transport and/or use in asphalt-containing applications.

3. The method of claim 2, wherein said further processing (d) comprises oxidizing or blending the CAPR with an aromatic extract or compatible oil to produce a flowable CAPR in the form of solid pellets or low viscosity liquid to facilitate transport.

4. The method of claim 3, further comprising blending the flowable CAPR into asphalt-containing materials.

5. The method of claim 4, wherein the asphalt-containing materials comprise materials for paving and/or roofing applications.

6. The method of claim 2, wherein said further processing (d) comprises blending the CAPR with one or more other materials to produce a CAPR blend useful in one or more asphalt-containing application.

7. The method of claim 6, wherein said further processing (d) comprises blending the CAPR with an asphalt-containing material at a weight percent of about 0.5-100%.

8. The method of claim 7, wherein said further processing (d) comprises blending the CAPR with an asphalt-containing material at a weight percent of about 0.5-30%.

9. The method of claim 8, wherein said further processing (d) comprises blending the CAPR with an asphalt-containing material at a weight percent of about 5-30/a.

10. The method of claim 6, wherein the other materials comprise one or more asphalt-containing material selected from the group consisting of paving grade asphalt binder, roofing grade asphalt binder, base asphalt, and combinations thereof.

11. The method of claim 1, further comprising removal of the CAPR from the SDA or VDU, and feeding remaining material, including the hydrocarbon solvent, to hydrotreating and/or lube fractionation systems to produce heavy base oil.

12. The method of claim 11, further comprising separating and recovering the hydrocarbon solvent from the remaining material at the hydrotreating and/or lube fractionation systems for reuse in the SDA.

13. The method of claim 11, further comprising oxidizing or blending the CAPR with an aromatic extract or compatible oil to produce a flowable CAPR in the form of solid pellets or low viscosity liquid.

14. The method of claim 13, further comprising blending the flowable CAPR blend into asphalt-containing materials for paving and/or roofing applications.

15. The method of claim 1, wherein said collecting (c) further comprises feeding the hydrocarbon solvent along with the VTAE to the SDA at a solvent:VTAE ratio of 5-20:1.

16. The method of claim 15, wherein said collecting (c) further comprises feeding the hydrocarbon solvent along with the VTAE to the SDA at a solvent:VTAE ratio of 12 to 1.

17. The method of claim 1, wherein the hydrocarbon solvent comprises at least one petroleum-derived hydrocarbon solvent.

18. The method of claim 17, wherein the hydrocarbon solvent comprises propane.

19. The method of claim 17, wherein the hydrocarbon solvent includes one or more of propane, pentane, hexane, n-pentane, n-heptane, and mixtures and combinations thereof.

20. The method of claim 1, wherein the CAPR comprises metals selected from the group consisting of aluminum, barium, beryllium, boron, cadmium, calcium, chromium, cobalt, copper, iron, lead, lithium, molybdenum, manganese, magnesium, nickel, phosphorous, potassium, silver, sodium, tin, titanium, vanadium, and zinc.

21. The method of claim 20, wherein the CAPR comprises a polymer modified asphalt or bitumen formulation comprising:
(a) about 1-98% by weight of a base asphalt or bitumen;
(b) about 2-30% by weight of at least one or more bituminous modifier selected from the group consisting of atactic polypropylene, styrene-butadiene-sytrene (SBS), styrene-butadiene rubber (SBR), styrene-ethylene-butadiene-sytrene (SEBS), styrene-isoprene-styrene (SIBS), ethylene vinyl acetate, ethylene methacrylate, ethylene butyl acrylate, polyethylene (PE);
ethylene glycidyl methacrylate (EGMA) butyl rubber, and mixtures thereof.

22. A Concentrated Asphaltene Polymer Residue (CAPR) comprising:
depleted polymer from the group consisting of Ethylene-propylene copolymers and hydrogenated styrene-diene copolymers (butadiene, isoprene), Polymethacrylate (PMA) Polymers, polyisobutenes (PIB), poly (alkyl methacrylates), poly (styrene-dienes), polyisoperenes, olefin copolymers (OCPs), and combinations thereof;
wear metals selected from the group consisting of aluminum, barium, boron, cadmium, calcium, chromium, copper, iron, lead, molybdenum, manganese, magnesium, nickel, phosphorous, silver, sodium, tin, titanium, vanadium, zinc, and combinations thereof; and
a polymer modified asphalt or bitumen formulation including:
(a) about 1-98% by weight of a base asphalt or bitumen; and
(b) about 2-30% by weight of at least one or more bituminous modifier selected from the group consisting of atactic polypropylene, styrene-butadiene-sytrene (SBS), styrene-butadiene rubber (SBR), styrene-ethylene-butadiene-sytrene (SEBS), styrene-isoprene-styrene (SIBS), ethylene vinyl acetate, ethylene methacrylate, ethylene butyl acrylate, polyethylene (PE), ethylene glycidyl methacrylate (EGMA) butyl rubber, and combinations thereof.

23. A method for refining residual Vacuum Tower Asphalt Extender (VTAE) collected in a Vacuum Distillation Bottom (VDB) of a Vacuum Distillation Column (VDC) when re-refining used lubricating oils containing depleted polymer additives and wear metals, the method comprising:
(a) feeding used lubricating oils as a feedstock to a dehydration/fuel stripping unit to create de-watered/defueled feedstock;
(b) feeding the de-watered/defueled feedstock to a VDC to remove and send lighter fractions for processing into base oil; and
(c) collecting VTAE from the VDB of the VDC and feeding the VTAE to a Vacuum Distillation Unit (VDU), along with a hydrocarbon solvent, to create a Concentrated Asphaltene Polymer Residue (CAPR) containing concentrations of the depleted polymer additives and wear metals.
